(19) United States
(12) Patent Application Publication
(10) Pub. No.: US 2015/0016573 A1
(43) Pub. Date: Jan. 15, 2015

(54) SYSTEM AND METHOD FOR PASSIVE WIRELESS MONITORING WITH EFFICIENT CHANNELIZATION

(71) Applicant: Verint Systems Ltd., Herzelia (IL)

(72) Inventor: Benjamin Imanilov, Herzelia (IL)

(21) Appl. No.: 14/324,026

(22) Filed: Jul. 3, 2014

(30) Foreign Application Priority Data
Jul. 9, 2013 (IL) 227401

(51) Int. Cl. H04B 7/08; H04L 27/00; H04L 27/26

(52) U.S. Cl. CPC H04B 7/0885; H04L 27/265; H04L 27/0002
USPC 375/340

(57) ABSTRACT

Methods and systems for passive monitoring and analysis of large numbers of cellular communication channels. The processing functions of a monitoring system are split between a front-end processor and a host that communicate over an interface. The front-end processor may comprise a signal-processing board installed in the computer, and the interface comprises a Peripheral Component Interconnect Express (PCIe) bus. A Radio Frequency (RF) receiver receives and down-coverts one or more RF bands of interest, which comprise a large number of communication channels. The front-end processor digitizes the received signals and produces a plurality of single-channel digital signals. In order to avoid high data rates, the front-end processor generates and sends to the host multi-channel digital signals instead of single-channel digital signals for processing. Each multi-channel digital signal comprises a respective set of communication channels (e.g., four channels), which are distributed over frequency.

### FIELD OF THE DISCLOSURE

The present disclosure relates generally to signal processing, and particularly to methods and systems for reception and processing of radio signals.

### BACKGROUND OF THE DISCLOSURE

Various systems, such as software radios, comprise a receiver that receives and processes radio signals. Processing of radio signals typically involves down-conversion, digitization and processing of the resulting digital signals. Several off-the-shelf products provide such capabilities. For example, Ettus Research (Mountain View, Calif.) offers a family of Universal Software Radio Peripheral (USRP™) products. A product sheet entitled “USRP N200/N210 Networked Series,” September, 2012, is incorporated herein by reference.

As another example, Pentek Inc. (Upper Saddle River, N.J.) offers a line of multichannel, high-speed data converters called Cobalt®. Two example product sheets of data converters denoted Model 78660 (June, 2012) and Model 78662 (March, 2013) are incorporated herein by reference. As yet another example, Spectrum Signal Processing by Vecima (Burnaby, British Columbia) offers a wideband digital receiver/digitizer module called XMC-1151. A data sheet of this product (September, 2012) is also incorporated herein by reference.

### SUMMARY OF THE DISCLOSURE

An embodiment that is described herein provides a method, which includes receiving an analog signal including multiple communication channels. Multiple single-channel digital signals are derived from the analog signal, each including a single respective one of the communication channels. Multi-channel digital signals, each including a respective set of the communication channels that are over-sampled and distributed over frequency, are generated from the single-channel digital signals. The multi-channel digital signals are sent to a host over an interface.

In some embodiments, the communication channels include Global System for Mobile telecommunication (GSM) channels. In an embodiment, deriving the single-channel digital signals includes digitizing the analog signal with a predefined over-sampling ratio relative to a symbol rate of the communication channels.

In some embodiments, generating the multi-channel digital signals includes frequency-shifting one or more of the single-channel digital signals in a given set, and summing the single-channel digital signals. Frequency-shifting the single-channel digital signals may include multiplying the single-channel digital signals by respective sequences of complex phase rotation values. Alternatively, frequency-shifting and summing the single-channel digital may include applying a Fourier Transform process.

In a disclosed embodiment, deriving the single-channel digital signals includes filtering each communication channel with a bandwidth that is smaller than a symbol rate of the communication channel, and generating the multi-channel digital signals includes positioning the communication channels in each multi-channel digital signal with a frequency spacing that is equal to the symbol rate.

In some embodiments, the communication channels are extracted in the host from the digital multi-channel signals, and the extracted communication channels are processed. Extracting a communication channel from a multi-channel digital signal may include frequency-shifting the multi-channel digital signal such that the communication channel is shifted to baseband, and filtering the communication channel from the frequency-shifted multi-channel digital signal. In an embodiment, frequency-shifting the multi-channel digital signal includes multiplying the multi-channel digital signal by a sequence of complex phase rotation values. In another embodiment, frequency-shifting and filtering the multi-channel digital signal includes applying a Fourier Transform process.

There is additionally provided, in accordance with an embodiment that is described herein, an apparatus including a host interface and a front-end processor. The host interface is configured for communicating with a host. The front-end processor is configured to receive an analog signal including multiple communication channels, to derive from the analog signal multiple single-channel digital signals each including a single respective one of the communication channels, to generate from the single-channel digital signals multi-channel digital signals, each including a respective set of the communication channels that are over-sampled and distributed over frequency, and to send the multi-channel digital signals to the host over the interface.

There is also provided, in accordance with an embodiment that is described herein, a system including a Radio Frequency (RF) receiver, a front-end processor and a host. The RF receiver is configured to receive an RF signal including multiple communication channels, and to down-convert the RF signal so as to produce an analog signal. The front-end processor is configured to derive from the analog signal multiple single-channel digital signals each including a single respective one of the communication channels, to generate from the single-channel digital signals multi-channel digital signals, each including a respective set of the communication channels that are over-sampled and distributed over frequency, and to send the multi-channel digital signals over the interface. The host is configured to receive the multi-channel digital signals over the interface, to extract the communication channels from the multi-channel digital signals, and to process the extracted communication channels.

The present disclosure will be more fully understood from the following detailed description of the embodiments thereof, taken together with the drawings in which:

### BRIEF DESCRIPTION OF THE DRAWINGS

FIG. 1 is a block diagram that schematically illustrates a passive wireless monitoring system, in accordance with an embodiment that is described herein;

FIG. 2A is a graph showing a monitored wireless communication band that includes multiple GSM channels, in accordance with an embodiment that is described herein;

FIG. 2B is a graph showing a single monitored communication channel, in accordance with an embodiment that is described herein;

FIG. 3A is a graph showing an over-sampled digital signal comprising a single communication channel, in accordance with an embodiment that is described herein;

FIG. 3B is a graph showing an over-sampled digital signal comprising multiple communication channels, in accordance with an embodiment that is described herein; and

FIG. 4 is a flow chart that schematically illustrates a method for passive wireless monitoring, in accordance with an embodiment that is described herein.

### DETAILED DESCRIPTION OF EMBODIMENTS

### Overview

Embodiments that are described herein provide improved methods and systems for receiving and processing multiple radio communication channels. The disclosed techniques can be used, for example, for passive monitoring and analysis of large numbers of cellular communication channels. One example embodiment comprises a passive monitoring system for Global System for Mobile telecommunication (GSM) channels.

In some embodiments, the processing functions of a monitoring system are split between a front-end processor and a host that communicate over an interface. In an example embodiment, the host comprises a personal computer, the front-end processor comprises a signal-processing board installed in the computer, and the interface comprises a Peripheral Component Interconnect Express (PCIe) bus.

In such a system, a Radio Frequency (RF) receiver receives and down-coverts one or more RF bands of interest, which comprise a large number of communication channels. The front-end processor digitizes the received signals and produces a plurality of single-channel digital signals. This process can be performed using hardware or firmware, as an acceleration procedure for a Software Defined Radio (SDR). Each single-channel digital signal comprises a single communication channel that is over-sampled with a certain predefined over-sampling ratio.

In principle, it is possible for the front-end processor to transfer the single-channel digital signals to the host for subsequent processing (e.g., demodulation and data extraction). This sort of solution, however, is problematic because of the extremely high data rate that is required over the interface between the front-end processor and the host. In some real-life scenarios that are addressed herein, this data rate may be on the order of 30 G, a rate that is far beyond the capabilities of a PCIe bus.

In order to avoid such high data rates, the front-end processor generates and sends to the host multi-channel digital signals instead of single-channel digital signals. Each multi-channel digital signal comprises a respective set of communication channels (e.g., four channels), which are distributed over frequency.

By using this technique, the front-end processor takes advantage of the fact that only a small portion of the spectrum of the single-channel digital signals actually contains signal energy. This property is due to the over-sampling and filtering of the single-channel digital signals, and also because the GSM channel spacing (200 KHz, which determines the filtering bandwidth) is narrower than the symbol rate (˜270.83 KHz, which determines the over-sampling rate).

Exploiting this property, the front-end processor superimposes sets of single-channel digital signals with appropriate frequency shifts, so as to produce the multi-channel digital signals. This signal format uses the over-sampled range much more efficiently. As will be shown below, the multi-channel digital signals can be produced by computationally-simple operations such as sign changes and In-phase/Quadrature (I/Q) swapping, or using a Fourier-Transform process such as Discrete Fourier Transform (DFT), Fast Fourier Transform (FFT) or a technique based on such transforms.

The resulting multi-channel signals have the same sampling rate as the single-channel signals, but their number is considerably smaller. Therefore, the data rate over the interface is reduced by a factor that is equal to the number of channels per multi-channel signal. As a result, the interface data rate no longer limits the maximum number of channels that can be processed simultaneously by the system.

The host typically receives the multi-channel digital signals over the interface, and filters them in order to demodulate the individual communication channels. This filtering operation is computationally simple and can be implemented in software, because the frequency separation between channels in the multi-channel digital signals is relatively large. Parsing the multi-channel signals to derive the individual channels can also be produced by computationally-simple operations such as sign changes and In-phase/Quadrature (I/Q) swapping, or using a Fourier-Transform process.

The property of frequency spacing being smaller than channel bandwidth is particularly noticeable in GSM, which makes the disclosed techniques especially attractive for GSM monitoring. Nevertheless, the methods and systems described herein can be used with various other types of communication channels.

### System Description

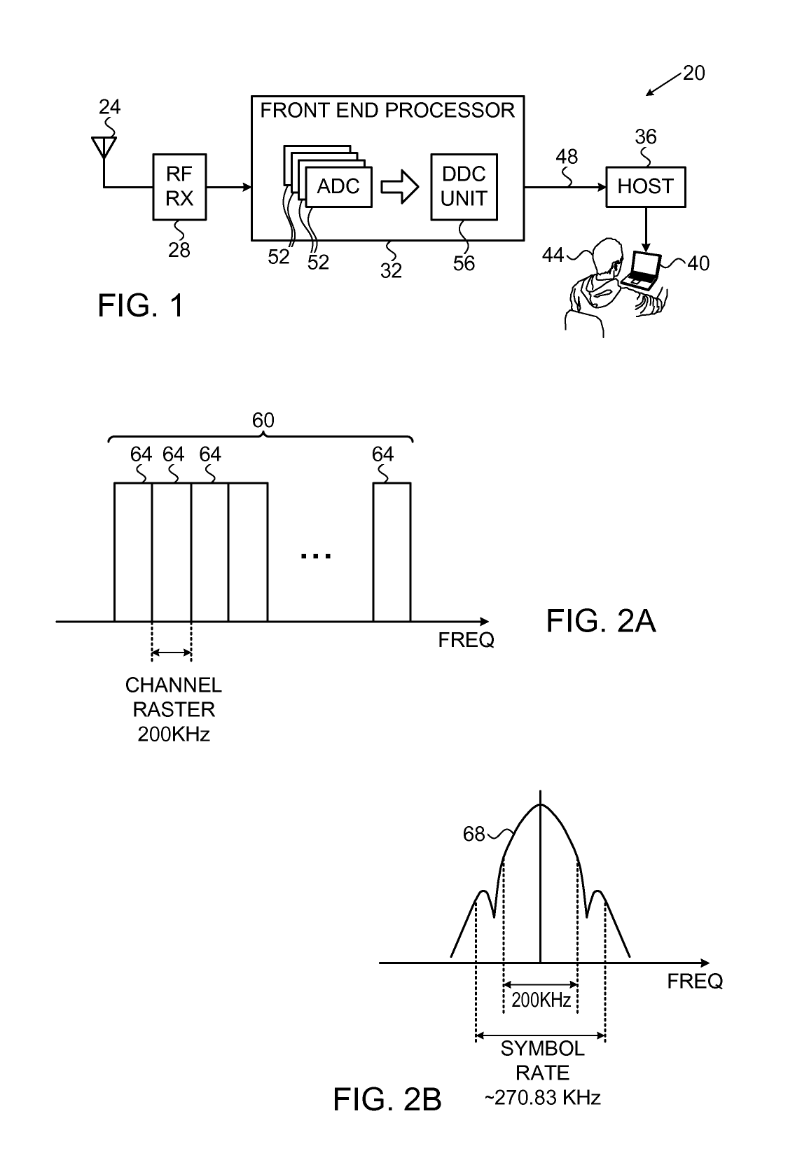

FIG. 1 is a block diagram that schematically illustrates a system 20 for passive wireless monitoring, in accordance with an embodiment that is described herein. System 20 is used for monitoring and analyzing multiple wireless communication channels in one or more frequency bands. Systems of this sort can be deployed, for example, for spectrum monitoring purposes, or as part of a law enforcement or Lawful Interception (LI) application.

In the present example, system 20 receives, demodulates and extracts data from a large number of Global System for Mobile telecommunication (GSM) channels in multiple bands simultaneously. In an example embodiment, system 20 is able to process all possible uplink and downlink GSM channels in the 900 and 1800 MHz bands simultaneously, totaling over 1000 channels. A system that also covers the 850 and 1900 MHz bands would need to process well over 2000 channels. In alternative embodiments, system 20 can be used for processing communication channels in accordance with any other suitable communication protocol, in any desired number of frequency bands and on any suitable frequency.

In the example of FIG. 1, system 20 comprises at least one antenna 24, which receives Radio Frequency (RF) signals in the band or bands of interest. The RF signals received by antenna 24 are provided to a RF receiver (RF RX) 28, which down-converts the RF signals to baseband. RF RX 28 outputs one or more broadband analog baseband signals (e.g., having a filtered bandwidth of between 25-75 MHz), each covering a respective band.

(The embodiment of FIG. 1 refers to a receiver that down-converts the RF signals to baseband. Generally, however, RF RX 28 may down-convert the RF signals to any suitable low frequency, e.g., baseband and/or Intermediate Frequency (IF) and/or low-IF. In an IF implementation, the analog signal produced by RF RX 28 may have a bandwidth of up to several hundred MHz.)

The analog signals are provided to a front-end processor 32. Front-end processor 32 digitizes the analog signals and generates digital signals that are sent to a host 36 for subsequent demodulation and analysis. The host typically demodulates the various communication channels, extracts the data conveyed by the channels, and presents the extracted data and/or additional information to an operator 44 using an operator terminal 40.

Front-end processor 32 sends the digital signals to host 36 over a high-speed interface 48. In the present example, host 36 comprises a personal computer, and interface 48 comprises a Peripheral Component Interconnect Express (PCIe) bus. In this embodiment, front-end processor 32 is implemented on a board that is plugged into a PCIe slot of the personal computer. For example, processor 32 may be implemented using the Pentek Model 78660 module, cited above, or using any other suitable platform.

In the embodiment of FIG. 1, front-end processor 32 comprises one or more Analog to Digital Converters (ADCs) 52 and a Digital Down-Conversion (DDC) unit 56. ADCs 52 digitize the analog signals received from RF RX 28.

In some embodiments (sometimes referred to as “complex” or I/Q configurations) the analog signals received from RF RX 28 comprise I/Q baseband or low-IF signals, in which case a given band is digitized by a pair of ADCs in a quadrature configuration. In alternative embodiments (sometimes referred to as “real” or “IF sampling” configurations) the analog signals received from RF RX 28 comprise IF signals, in which case a given band is digitized by a single high-speed ADC in an IF sampling configuration.

DDC unit 56 processes the digitized signals so as to produce digital single-channel signals, each comprising a single respective communication channel from among the multiple communication channels received in the RF signals. Unit 56 then combines sets of the single-channel signals, using techniques that will be described in detail below.

The process above produces multi-channel signals, each comprising a respective set of communication channels that are over-sampled and distributed in frequency. Processor 32 sends the multi-channel signals to host 36 over interface 48 for subsequent processing. As will be shown below, transmitting the multi-channel signals instead of the single-channel signals to the host reduces the data volume on interface 48 considerably.

The configurations of system 20 and front-end processor 32 shown in FIG. 1 are example configurations, which are chosen purely for the sake of conceptual clarity. In alternative embodiments, any other suitable configuration of system 20 and/or processor 32 can be used. Some elements of system 20, e.g., processor 32, may be implemented in hardware, e.g., in one or more Application-Specific Integrated Circuits (ASICs) or Field-Programmable Gate Arrays (FPGAs). Additionally or alternatively, some elements of system 20 can be implemented using software, or using a combination of hardware and software elements.

Typically, host 36 and/or processor 32 comprises one or more general-purpose processors, which are programmed in software to carry out the functions described herein. The software may be downloaded to the processors in electronic form, over a network, for example, or it may, alternatively or additionally, be provided and/or stored on non-transitory tangible media, such as magnetic, optical, or electronic memory.

FIG. 2A is a graph showing a monitored wireless communication band 60, in accordance with an embodiment that is described herein. Band 60 comprises multiple communication channels 64, of which some may be active and others may be inactive. In GSM, for example, band 60 may have a bandwidth on the order of 25-75 MHz. The channel raster (i.e., the channel spacing, or the spacing between the center frequencies of adjacent channels 64) is 200 KHz.

FIG. 2B is a graph showing a monitored GSM communication channel, in accordance with an embodiment that is described herein. A curve 68 shows the spectral response of the GSM signal. As can be seen in the figure, the symbol rate of the GSM signal is approximately 270.83 KHz, while the channel raster is 200 KHz. Therefore, some of the signal power falls outside the 200 KHz channel bandwidth. (In the description that follows, the GSM symbol rate is sometimes rounded from

$$270 \frac{5}{6} = 270.8333 …$$

to 270 KHz, for the sake of clarity.)

### Efficient Channelization Schemes for Reducing Data Volume Over Host Interface

As noted above, DDC unit 56 of front-end processor produces single-channel digital signals, such that each single-channel digital signal comprises a single GSM channel. In some embodiments, the front-end processor digitizes the GSM channels with a certain over-sampling ratio, i.e., with a sampling rate that produces multiple samples per symbol. The over-sampling ratio is defined as the ratio between the sampling rate and the symbol rate of a GSM channel.

Over-sampling is advantageous for subsequent processing of the signal, e.g., for accurate timing and frequency synchronization, channel estimation and/or equalization. In the present example, the over-sampling ratio is four, i.e., each GSM channel is sampled with four complex samples per symbol. Alternatively, however, any other suitable over-sampling ratio can be used.

Although beneficial for performance, over-sampling causes a considerable increase in data volume. In particular, the bandwidth required for sending the single-channel digital signals over interface 48 to host 36 becomes prohibitive. Consider, for example, a scenario in which system 20 monitors a total of 1100 GSM channels (the total number of uplink and downlink channels in a pair of 850 & 1900 MHz, or 900 & 1800 MHz, GSM bands). Assuming an over-sampling ratio of four and a DDC output resolution of twenty-four bits per sample, the required bandwidth of interface 48 is 32 Gbps.

This sort of bandwidth is beyond the capabilities of the PCIe interface. Therefore, unless accounted for, the bandwidth of interface 48 becomes the bottleneck that limits the number of channels that can be processed by system 20. The techniques described herein reduce the required bandwidth on interface 48, with little or no degradation in demodulation performance.

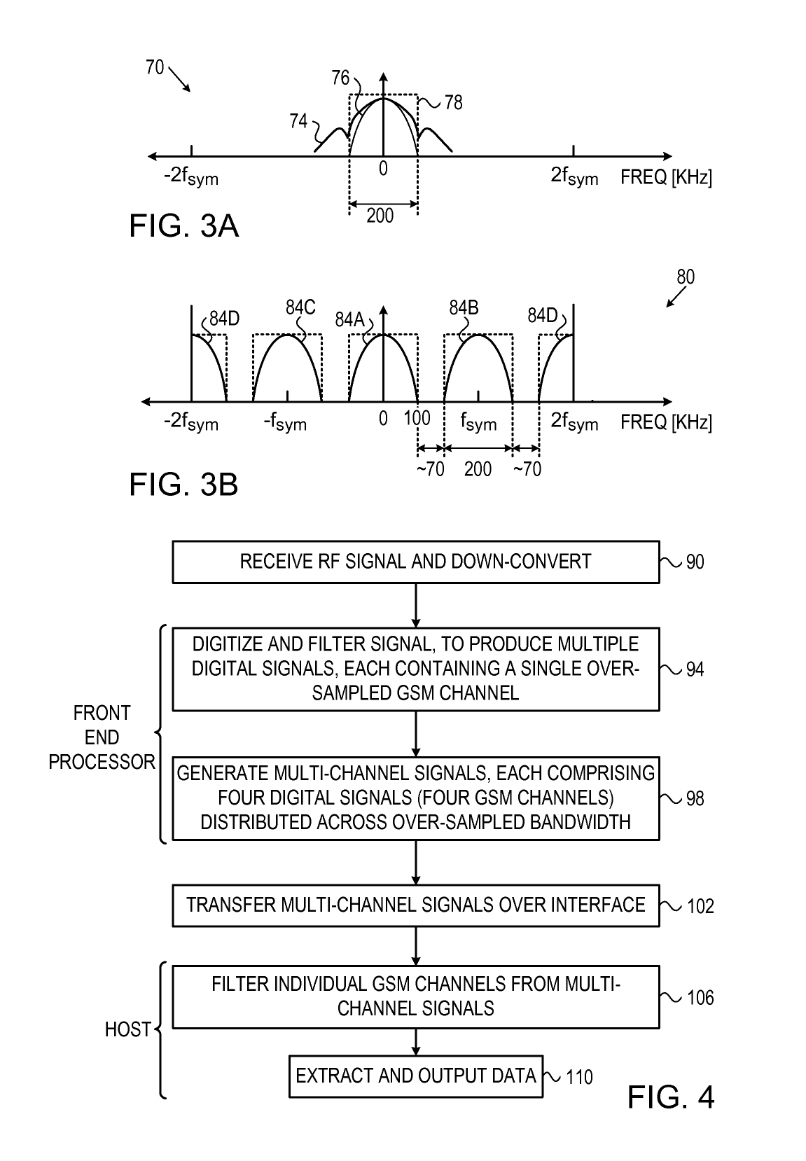

FIG. 3A is a graph 70 showing spectra of an over-sampled single-channel digital signal, before and after channel filtering, in accordance with an embodiment that is described herein. Typically, DDC unit 56 produces a signal of this sort for each of the GSM channels to be monitored by system 20. The un-filtered GSM channel is shown by a curve 74. The 200 KHz channel bandwidth is shown by a dashed curve 78. The DDC unit typically filters the GSM channel according to the 200 KHz channel bandwidth in order to reject adjacent channels. The filtered GSM channel is shown by a curve 76.

The GSM symbol rate of 270⅚ KHz is denoted f_{sym}. In the present example, the single-channel digital signal has an over-sampling ratio of four, i.e., a sampling rate of f_{sym}×4≅1083.33 KHz. The signal is represented by a complex representation, i.e., by an in-phase component and a quadrature component. The spectrum of such a signal is defined in the range [−2f_{sym},2f_{sym}]≅[−541.66 KHz, 541.66 KHz] on the frequency axis.

In a typical embodiment, DDC unit 56 produces each single-channel signal by digitally shifting the center frequency of the desired GSM channel to baseband (i.e., to zero Hz), resulting in a signal 74. The DDC unit filters signal 74 with a sharp digital Low-Pass Filter (LPF) to produce signal 76. Any suitable digital down-conversion and filtering schemes can be used for this purpose.

As can be seen in the figure, a large portion of the spectral range [−2f_{sym},2f_{sym}] has no signal energy, due to the high over-sampling ratio. This is especially true when the signal is filtered sharply, in which case most of the signal energy is confined to the central 200 KHz (curve 76). This representation demonstrates that sending the single-channel signals in this format to host 36 is extremely redundant and inefficient in terms of bandwidth.

In order to reduce the required bandwidth on interface 48, in some embodiments DDC unit 56 converts the single-channel digital signals into multi-channel digital signals, such that each multi-channel digital signal comprises a respective set of single-channel digital signals that are distributed in frequency over the over-sampled range. Front-end processor 32 sends the multi-channel signals, and not the single-channel signals, over interface 48 to host 36. As a result, the data rate over interface 48 is reduced by a factor that is equal to the number of GSM channels per multi-channel digital signal.

FIG. 3B is a graph showing a spectrum 80 of an over-sampled multi-channel digital signal, in accordance with an embodiment that is described herein. In the present example, the multi-channel digital signal comprises four GSM channels 84A . . . 84D that are distributed evenly in the over-sampled range [−2f_{sym},2f_{sym}].

Typically, DDC unit 56 produces each multi-channel digital signal of this sort from a respective set of four single-channel digital signals. The DDC unit may produce such a signal, for example, by:
Shifting the frequency of one of the single-channel digital signals from baseband to a center frequency of f_{sym} (˜270 KHz), to produce signal 84B.
Shifting the frequency of another single-channel digital signal from baseband to a center frequency of −f_{sym} (˜−270 KHz), to produce signal 84C.
Shifting the frequency of yet another single-channel digital signal from baseband to a center frequency of 2f_{sym} (or equivalently −2f_{sym}), to produce signal 84D. (Since 2f_{sym}≅541.66 KHz is the Nyquist frequency for this signal, signal 84D is shown in the figure split into two, with its center frequency at 2f_{sym} or −2f_{sym}.)
Positioning another single-channel digital signal at DC without shifting
Summing signals 84A . . . 84D to produce the multi-channel digital signal. (The single-channel signal corresponding to signal 84A, which is originally centered at baseband, is summed without frequency shift.)

The frequency shifting and summing procedure can be also performed by a Fourier Transform process, e.g., FFT, DFT or a technique based on such transforms. In some embodiments, the frequency shifts of signals 84B, 84C and 84D can be implemented efficiently in DDC unit 56, by using the fact that these frequency shifts are equivalent to ±¼ and ½ of the sampling rate.

Shifting by ¼ of the sampling rate can be implemented by multiplication by the complex sequence +1, +j, −1, −j, +1, +j, −1, −j, . . . . This multiplication can be performed by sign changes and/or I/Q swapping operations that are simple to implement. Shifting by −¼ of the sampling rate can be implemented by multiplication by the complex sequence +1, −j, −1, +j, +1, −j, −1, +j, . . . . This multiplication, too, can be performed by sign changes and/or I/Q swapping. Shifting by ½ of the sampling rate can be implemented by multiplication by the real sequence +1, −1, +1, −1, +1, . . . that can be performed by sign changes. Sequences of this sort are referred to herein as sequences of complex phase rotation values.

In alternative embodiments, the frequency shifting and summing procedure above can be performed using a Fourier Transform process, as explained above. As will be described below, Fourier Transform processes can also be used in the host for extracting the individual GSM channels from the multi-channel signals.

Consider the multi-channel signal of FIG. 3B in comparison with the single-channel signal of FIG. 3A above. Both signals have the same sampling rate of f_{sym}×4≅1083.33 KHz, but the multi-channel signal of FIG. 3B comprises four times as many GSM channels. Therefore, sending multi-channel digital signals over interface 48, instead of single-channel signals, reduces the data rate over the interface by a factor of four.

Using this technique, the bandwidth of interface 48 no longer limits the number of GSM channels that can be processed simultaneously by system 20. For example, the desired capacity of 1100 GSM channels can be supported with a conventional PCIe interface.

As noted above, an over-sampling ratio of four was chosen purely by way of example. In alternative embodiments, the single-channel and multi-channel digital signals in system 20 may be sampled with any other suitable over-sampling ratio. Additionally or alternatively, DDC unit 56 may combine any desired number of single-channel signals into the respective multi-channel signal.

The multi-channel digital signals, of the form shown in FIG. 3B, are received by host 36 from interface 48. Host 36 extracts the individual GSM channels (e.g., signals 84A . . . 84D) from the multi-channel digital signals, demodulates the data from the GSM channels and provides the data to operator 44.

In some embodiments, in order to extract a certain GSM channel from a multi-channel digital signal, host 36 shifts the frequency of the multi-channel digital signal such that the desired GSM channel is centered at baseband, and filters the frequency-shifted signal with a suitable LPF. (If the desired GSM channel is already centered at baseband, e.g., signal 84A, the host applies filtering without frequency shifting.). Alternatively, this process can be carried out by a Fourier Transform process.

As can be seen in the figure, adjacent GSM channels are separated by a ˜70 KHz transition band, which is sufficient for filtering out the adjacent channels with a modest-complexity LPF. An LPF of this sort may be implemented in software running on host 36. Channel spacing of ¼ and ½ over-sampling frequency also enables using Fourier Transform processes efficiently.

The above-described scheme is particularly suitable for GSM, because in GSM each channel is filtered with a bandwidth that is smaller than the symbol rate (200 KHz filtering for a ˜270 KHz symbol rate). Then, the individual GSM channels are positioned in the multi-channel digital signal with a frequency spacing that is equal to the symbol rate. This difference produces the 70 KHz transition region that enables the host to filter-out the individual GSM channels from the multi-channel digital signals.

In some embodiments, the host may shift the frequency of the multi-channel digital signal by multiplication with the phase rotation sequences described above, since these frequency shifts are also by ½ and ±¼ of the sampling frequency. This process can alternatively be performed by a Fourier Transform process.

FIG. 4 is a flow chart that schematically illustrates a method for passive wireless monitoring, in accordance with an embodiment that is described herein. The method begins with RF RX 28 receiving an RF signal that comprises multiple GSM channels, at a reception step 90. The RF RX down-converts the RF signal to baseband and/or IF and/or low-IF, and provides the resulting analog signal to front-end processor 32.

Front-end processor 32 converts the analog signal into a plurality of single-channel digital signals, at a single-channel generation step 94. Each single-channel digital signal comprises a single GSM channel, selected from the multiple GSM channels in the analog signal.

Typically, for a Direct Conversion Receiver (DCR), ADCs 52 digitize the analog signal with an ADC sampling frequency of at least twice the GSM band bandwidth for a real ADC configuration, and at least the GSM band bandwidth for a complex ADC configuration. In case of low-IF and/or IF receiver, the ADC sampling frequency should typically be much higher.

DDC unit 56 performs sampling reduction to a target over-sampling rate (e.g., four), and the appropriate frequency shifting and filtering operations to produce the single-channel digital signals. The resulting single-channel digital signals have a spectrum such as shown in FIG. 3A above.

Front-end processor 32 combines sets of single-channel digital signals to produce multi-channel digital signals, at a multi-channel generation step 98. As explained above, DDC unit 56 produces each multi-channel digital signal from a set of (typically adjacent) single-channel digital signals by applying appropriate frequency shifts. Each multi-channel digital signal comprises multiple (e.g., four) GSM channels that are distributed over the over-sampled range. The resulting multi-channel digital signals have a spectrum such as shown in FIG. 3B above.

Front-end processor 32 sends the multi-channel digital signals to host 36 over interface 48, at a signal transfer step 102. Host 36 filters the individual GSM channels from the multi-channel digital signals, at a host filtering step 106. The host demodulates the GSM channels so as to extract the data, at a data extraction step, and outputs the data to operator 44 using terminal 40.

Although the embodiments described herein mainly address GSM channels, the principles of the present disclosure can also be used for other communication protocols, such as General Packet Radio Service (GPRS) or Enhanced Data rates for GSM Evolution (EDGE).

It will thus be appreciated that the embodiments described above are cited by way of example, and that the present disclosure is not limited to what has been particularly shown and described hereinabove. Rather, the scope of the present disclosure includes both combinations and sub-combinations of the various features described hereinabove, as well as variations and modifications thereof which would occur to persons skilled in the art upon reading the foregoing description and which are not disclosed in the prior art. Documents incorporated by reference in the present patent application are to be considered an integral part of the application except that to the extent any terms are defined in these incorporated documents in a manner that conflicts with the definitions made explicitly or implicitly in the present specification, only the definitions in the present specification should be considered.

1. A method, comprising:
receiving an analog signal comprising multiple communication channels;
deriving from the analog signal multiple single-channel digital signals, each comprising a single respective one of the communication channels;
generating from the single-channel digital signals multi-channel digital signals, each comprising a respective set of the communication channels that are over-sampled and distributed over frequency; and
sending the multi-channel digital signals to a host over an interface.

2. The method according to claim 1, wherein the communication channels comprise Global System for Mobile telecommunication (GSM) channels.

3. The method according to claim 1, wherein deriving the single-channel digital signals comprises digitizing the analog signal with a predefined over-sampling ratio relative to a symbol rate of the communication channels.

4. The method according to claim 1, wherein generating the multi-channel digital signals comprises frequency-shifting one or more of the single-channel digital signals in a given set, and summing the single-channel digital signals.

5. The method according to claim 4, wherein frequency-shifting the single-channel digital signals comprises multiplying the single-channel digital signals by respective sequences of complex phase rotation values.

6. The method according to claim 4, wherein frequency-shifting and summing the single-channel digital comprises applying a Fourier Transform process.

7. The method according to claim 1, wherein deriving the single-channel digital signals comprises filtering each communication channel with a bandwidth that is smaller than a symbol rate of the communication channel, and wherein generating the multi-channel digital signals comprises positioning the communication channels in each multi-channel digital signal with a frequency spacing that is equal to the symbol rate.

8. The method according to claim 1, and comprising, in the host, extracting the communication channels from the digital multi-channel signals, and processing the extracted communication channels.

9. The method according to claim 8, wherein extracting a communication channel from a multi-channel digital signal comprises frequency-shifting the multi-channel digital signal such that the communication channel is shifted to baseband, and filtering the communication channel from the frequency-shifted multi-channel digital signal.

10. The method according to claim 9, wherein frequency-shifting the multi-channel digital signal comprises multiplying the multi-channel digital signal by a sequence of complex phase rotation values.

11. The method according to claim 9, wherein frequency-shifting and filtering the multi-channel digital signal comprises applying a Fourier Transform process.

12. Apparatus, comprising:
a host interface for communicating with a host; and
a front-end processor, which is configured to receive an analog signal comprising multiple communication channels, to derive from the analog signal multiple single-channel digital signals each comprising a single respective one of the communication channels, to generate from the single-channel digital signals multi-channel digital signals, each comprising a respective set of the communication channels that are over-sampled and distributed over frequency, and to send the multi-channel digital signals to the host over the interface.

13. The apparatus according to claim 12, wherein the communication channels comprise Global System for Mobile telecommunication (GSM) channels.

14. The apparatus according to claim 12, wherein the front-end processor is configured to digitize the analog signal with a predefined over-sampling ratio relative to a symbol rate of the communication channels.

15. The apparatus according to claim 12, wherein the front-end processor is configured to generate the multi-channel digital signals by frequency-shifting one or more of the single-channel digital signals in a given set, and summing the single-channel digital signals.

16. The apparatus according to claim 15, wherein the front-end processor is configured to shift the single-channel digital signals by multiplying the single-channel digital signals by respective sequences of complex phase rotation values.

17. The apparatus according to claim 15, wherein the front-end processor is configured to frequency-shift and sum the single-channel digital signals by applying a Fourier Transform process.

18. The apparatus according to claim 12, wherein the front-end processor is configured to filter each communication channel with a bandwidth that is smaller than a symbol rate of the communication channel, and to position the communication channels in each multi-channel digital signal with a frequency spacing that is equal to the symbol rate.

19. A system, comprising:
a Radio Frequency (RF) receiver, which is configured to receive an RF signal comprising multiple communication channels, and to down-convert the RF signal so as to produce an analog signal;
a front-end processor, which is configured to derive from the analog signal multiple single-channel digital signals each comprising a single respective one of the communication channels, to generate from the single-channel digital signals multi-channel digital signals, each comprising a respective set of the communication channels that are over-sampled and distributed over frequency, and to send the multi-channel digital signals over the interface; and
a host, which is configured to receive the multi-channel digital signals over the interface, to extract the communication channels from the multi-channel digital signals, and to process the extracted communication channels.

20. The apparatus according to claim 19, wherein the host is configured to extract a communication channel from a multi-channel digital signal by frequency-shifting the multi-channel digital signal such that the communication channel is shifted to baseband, and filtering the communication channel from the frequency-shifted multi-channel digital signal.
